(19) United States
(12) Patent Application Publication
(10) Pub. No.: US 2025/0313353 A1
(43) Pub. Date: Oct. 9, 2025

(54) APPARATUS FOR SETTING INITIAL LOCATION OF AERIAL VEHICLE FOR REPLACEMENT OF AERIAL VEHICLE OF MOBILE BACKHAUL SYSTEM AND METHOD OF SETTING INITIAL LOCATION OF AERIAL VEHICLE USING THE SAME

(71) Applicant: ELECTRONICS AND TELECOMMUNICATIONS RESEARCH INSTITUTE, Daejeon (KR)

(72) Inventor: Kyung Yeol Sohn, Daejeon (KR)

(21) Appl. No.: 19/173,124

(22) Filed: Apr. 8, 2025

(30) Foreign Application Priority Data
Apr. 9, 2024 (KR) 10-2024-0048105

(51) Int. Cl. B64U 10/13; G08G 5/72

(52) U.S. Cl. CPC B64U 10/13; G08G 5/727; B64U 2201/104

(57) ABSTRACT

A method of setting an initial location of an aerial vehicle for the replacement of the aerial vehicle of a mobile backhaul system includes obtaining a first separation distance between a mobile backhaul hub and a first aerial vehicle, obtaining a second separation distance between a second aerial vehicle and the mobile backhaul hub by considering the location of the first aerial vehicle, a service area radius of a first flying base station mounted on the first aerial vehicle, and information on a handover overlap area in which handover to the second aerial vehicle is considered, calculating an angle of interference for 3-D rotation transformation based on the first separation distance and the second separation distance, and calculating location information of the second aerial vehicle to be replaced based on coordinate transformation and 3-D rotation transformation with respect to the location information of the first aerial vehicle.

### CROSS-REFERENCE TO RELATED APPLICATION

This application claims priority to and the benefit of Korean Patent Application No. 10-2024-0048105 filed on Apr. 9, 2024, the disclosures of which are incorporated herein by reference in their entirety.

### BACKGROUND

### 1. Technical Field

The present disclosure relates to an apparatus and method for setting the initial location of an aerial vehicle for the replacement of the aerial vehicle of a mobile backhaul system.

### 2. Description of Related Art

As a high-speed/high-reliability wireless backhaul capable of broad band transmission is being developed, the application field of the wireless backhaul is widened to fields, such as a wireless mobile backhaul using an aerial vehicle such as a drone.

However, as a sufficient flight time of the aerial vehicle is not secured due to various factors, leading to the problem of being unable to perform long-term missions such as providing dedicated wireless links to support wireless access network services.

### SUMMARY

Various embodiments are directed to an apparatus for setting an initial location of an aerial vehicle for the replacement of the aerial vehicle of a mobile backhaul system, which can maintain/guarantee the connectivity of a service that is being performed by replacing an aerial vehicle so that a long-term mission can be performed, and a method of setting an initial location of an aerial vehicle using the same.

A method of setting an initial location of an aerial vehicle for the replacement of the aerial vehicle of a mobile backhaul system according to an embodiment of the present disclosure includes steps of (a) obtaining a first separation distance between a mobile backhaul hub and a first aerial vehicle, (b) obtaining a second separation distance between a second aerial vehicle and the mobile backhaul hub by considering the location of the first aerial vehicle, a service area radius of a first flying base station mounted on the first aerial vehicle, and information on a handover overlap area in which handover to the second aerial vehicle is considered, (c) calculating an angle of interference for three-dimensional (3-D) rotation transformation based on the first separation distance and the second separation distance, and (d) calculating location information of the second aerial vehicle to be replaced based on coordinate transformation and 3-D rotation transformation with respect to the location information of the first aerial vehicle.

The step (a) includes calculating the first separation distance based on latitude and longitude of the mobile backhaul hub and the first aerial vehicle.

The step (b) includes calculating the service area radius of the first flying base station based on information on GPS locations of the first aerial vehicle and a beam angle that is used by the first flying base station in order to provide a service.

The step (b) includes obtaining the second separation distance by considering the information on the handover overlap area including a maximum diameter of the handover overlap area.

The step (c) includes calculating the angle of interference by considering a relationship between the first separation distance and the second separation distance and a relationship between the service area radii of the first flying base station and a second flying base station mounted on the first aerial vehicle and the second aerial vehicle, respectively.

The step (d) includes obtaining an initial location at which the second aerial vehicle is to be located by performing 3-D Cartesian coordinate system transformation on information on GPS locations of the first aerial vehicle, performing 3-D rotation transformation on transformation values by considering an angle of interference, and transforming 3-D rotation transformation values into values of the information on the GPS locations again through 3-D Cartesian coordinate system transformation.

An apparatus for setting an initial location of an aerial vehicle for the replacement of the aerial vehicle of a mobile backhaul system according to an embodiment of the present disclosure includes an input interface device configured to obtain input information including location information of a mobile backhaul hub and a first aerial vehicle to be replaced, memory in which a program that calculates an initial location of a second aerial vehicle that replaces the first aerial vehicle and moves the second aerial vehicle based on the input information has been stored, and a processor configured to execute the program. The processor determines information on an initial location of the second aerial vehicle that replaces the first aerial vehicle by transforming the location information of the first aerial vehicle.

The input information further includes a service cell radius of a flying base station and information on handover of a user terminal that receives a service from the flying base station.

The processor determines the information on the initial location of the second aerial vehicle, by obtaining a first separation distance between the mobile backhaul hub and the first aerial vehicle, obtaining a second separation distance between the mobile backhaul hub and the second aerial vehicle by considering a service area radius of a first flying base station mounted on the first aerial vehicle and information on a handover overlap area, calculating an angle of interference based on the first separation distance and the second separation distance, and transforming the location information of the first aerial vehicle based on the angle of interference.

The processor calculates first coordinates by transforming the location information of the first aerial vehicle into geocentric coordinate systems, calculates second coordinates by performing three-dimensional (3-D) rotation transformation on the transformed first coordinates by the angle of interference, and determines information on the initial location of the second aerial vehicle by transforming the transformed second coordinates into geodetic coordinate systems.

A mobile backhaul system according to an embodiment of the present disclosure includes a first aerial vehicle on which a flying base station and a mobile backhaul terminal are mounted, and an aerial vehicle management apparatus configured to determine whether the first aerial vehicle needs to be replaced by receiving state information from the first aerial vehicle and analyzing the state information, calculate an initial location of a second aerial vehicle that replaces the first aerial vehicle by considering a separation distance, a service cell radius, and a maximum diameter of a handover overlap area when determining to replace the first aerial vehicle, and move the second aerial vehicle to the initial location.

The aerial vehicle management apparatus obtains a second separation distance between the mobile backhaul hub and the second aerial vehicle by considering a first separation distance between the mobile backhaul hub and the first aerial vehicle, a service area radius of a first flying base station mounted on the first aerial vehicle, and a maximum diameter in which handover to the second aerial vehicle is considered, and calculating an angle of interference for three-dimensional (3-D) rotation transformation based on the first separation distance and the second separation distance.

The aerial vehicle management apparatus obtains the initial location at which the second aerial vehicle is to be located by performing 3-D Cartesian coordinate system transformation on location information of the first aerial vehicle, performing 3-D rotation transformation on transformation values by considering the angle of interference, and transforming 3-D rotation transformation values into values of the location information again through 3-D Cartesian coordinate system transformation.

According to embodiments of the present disclosure, it is possible to continuously maintain a seamless mobile backhaul link by calculating and moving an initial location of an aerial vehicle that is replaced by considering information on the GPS locations of an aerial vehicle on which the mobile backhaul hub and the mobile backhaul terminal are mounted, the service cell radius of a flying base station mounted on the aerial vehicle, and the handover of a user terminal that receives a service from the flying base station.

Effects of the present disclosure which may be obtained in the present disclosure are not limited to the aforementioned effects, and other effects not described above may be evidently understood by those skilled in the art from the following description.

### BRIEF DESCRIPTION OF THE DRAWINGS

FIG. 1 is a concept view illustrating an example of the replacement of an aerial vehicle, that is, a component of a mobile backhaul system according to an embodiment of the present disclosure.

FIG. 2 is a block diagram illustrating a connection link for the transfer of signals between components of a mobile backhaul system according to an embodiment of the present disclosure.

FIG. 3 is a concept view illustrating an example of the setting of an initial location at which a new aerial vehicle will be moved for the replacement of an aerial vehicle according to an embodiment of the present disclosure.

FIG. 4 illustrates a process of obtaining an initial location to which a new aerial vehicle will be moved for replacement according to an embodiment of the present disclosure.

FIG. 5 is a flowchart of a process of calculating an initial location to which a new aerial vehicle will be moved for replacement according to an embodiment of the present disclosure.

FIG. 6 illustrates an example in which the existing aerial vehicle and a new aerial vehicle are moved for the replacement of the existing aerial vehicle according to an embodiment of the present disclosure.

FIG. 7 is a block diagram illustrating a computer system that implements a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Hereinafter, in order to help understanding of those skilled in the art, a contrived background of the present disclosure is described in detail.

Recently, due to the rapid development of the industry technology and the information communication technology, the development of a technology that aims as base services having an enhanced mobile broadband (eMBB), ultra reliable & low latency communication (URLLC), and massive machine-type communication (mMTC) is actively performed.

In particular, as it is expected that many small cells will be operated in 5^{th} generation (5G) communication compared to 4^{th} generation (4G) communication, a high-speed/high-reliability wireless backhaul that enables broad band transmission based on a millimeter wave band is being developed. The application field of the wireless backhaul tends to be widened to fields, such as a wireless mobile backhaul using an aerial vehicle such as a drone.

The application field using the aerial vehicle, such as a drone, corresponds to various industrial sites, fire sites, disaster monitoring fields, missing persons investigation fields, and hard-to-reach accident sites. The aerial vehicle requires the deployment of a dedicated wireless link for supporting a high-capacity application because the aerial vehicle can be easily deployed, has low purchasing and maintenance costs, and has a very high commercial value due to its mobility and the ability to hover in-mid air.

However, a middle and/or large-class aerial vehicle on which various devices, such as a sensor and a high-performance camera, are mounted has very short fuel or battery duration to the extent that the flight time of the aerial vehicle is merely 15 to 20 minutes due to various variables, such as a wind power condition, the weight of the aerial vehicle, and acceleration during flight. That is, there are limitations in performing long-term missions, such as providing dedicated wireless links to support continuous wireless access network services in specific areas.

Embodiments of the present disclosure have been contrived to solve the aforementioned problems, and propose an apparatus and method for setting an initial location of an aerial vehicle for the replacement of the aerial vehicle and more specifically, the setting of an initial location for the replacement of an aerial vehicle, that is, a component of a mobile backhaul system, when the battery of an aerial vehicle being served is consumed at a predetermined level or less, and a method for the setting of the initial location.

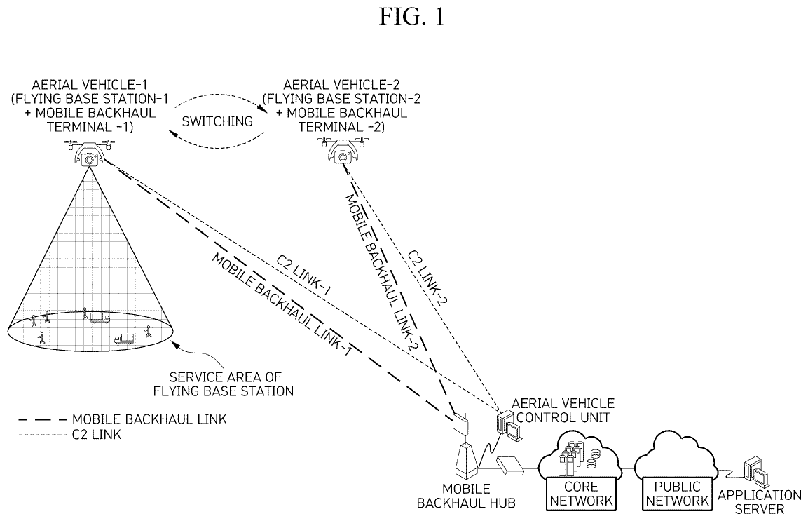

FIG. 1 is a concept view illustrating an example of the replacement of an aerial vehicle, that is, a component of a mobile backhaul system according to an embodiment of the present disclosure.

As illustrated in FIG. 1, the mobile backhaul system according to an embodiment of the present disclosure includes a mobile backhaul hub connected to a core network, a mobile backhaul terminal connected to the mobile backhaul hub, a flying base station that provides a 4G or 5G mobile communication system to user terminals on the ground, an aerial vehicle on which the mobile backhaul terminal and the flying base station are mounted and that stays in the upper air of an area in which mobile communication infrastructure is not present or is insufficient by being dispatched to the area, and an aerial vehicle control unit (or an aerial vehicle management apparatus) that monitors or controls the aerial vehicle.

Data that are transmitted to the core network are transmitted to an application server, such as Google, Twitter, or YouTube, via a public network connected to the core network.

A mobile backhaul link that connects the mobile backhaul hub and the mobile backhaul terminal requires a broadband transmission bandwidth for transmitting a large amount of data that are served by the flying base station mounted on the aerial vehicle up to the core network. To this end, the mobile backhaul link supports 4^{th} communication systems (e.g., LTE/LTE-A) supported by 3GPP, a 5^{th} communication system (e.g., new radio (NR)), or post 5^{th} communication systems.

In this case, if the mobile backhaul system supports the 4^{th} communication system, the core network includes a serving gateway (S-GW), a PDN gateway (P-GW), and a mobility management entity (MME). If the mobile backhaul system supports the 5^{th} communication system, the core network includes a user plane function (UPF), an access and mobility management function (AMF), and a session management function (SMF).

A command and control (C2) link that connects the aerial vehicle and the aerial vehicle management apparatus that monitors and controls the aerial vehicle indicates a link for control for supporting commands, such as the direction, speed, and posture control of the aerial vehicle in real time depending on an operator's intention on the ground. The C2 link support RF communication, Wi-Fi communication, a mobile communication system (4^{th} or 5^{th} generation), or a satellite communication system depending on an operation method of the aerial vehicle.

The mobile backhaul terminal connected to the mobile backhaul hub on the ground through the mobile backhaul link and the flying base station that sets an access link to the user terminal on the ground are mounted on the aerial vehicle. The aerial vehicle needs to hover in the air for a long time of a preset time or more depending on a mission to which the mobile backhaul system is applied, and to maintain or guarantee the connectivity of a service being in progress. A smooth service can be provided through replacement into a new aerial vehicle (switching, the exchange of an aerial vehicle—1 and an aerial vehicle—2) when fuel that is used by the aerial vehicle or the limits of a battery is considered.

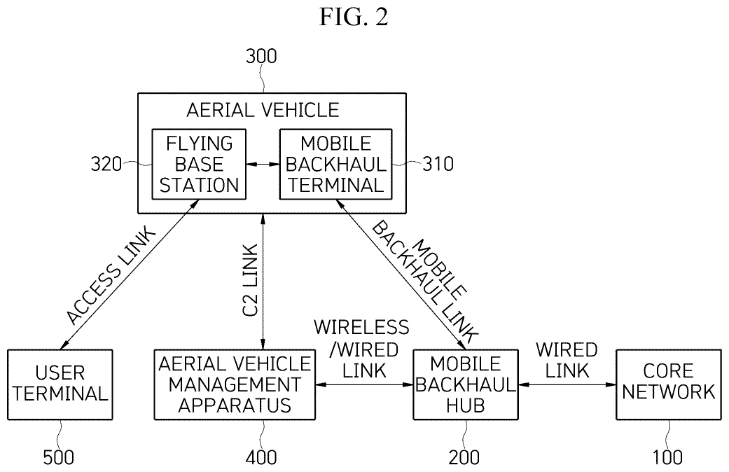

FIG. 2 is a block diagram illustrating a connection link for the transfer of signals between components of a mobile backhaul system according to an embodiment of the present disclosure.

Referring to FIG. 2, a mobile backhaul link for transmitting data by using a millimeter wave (mmWave) band or a 5G band is present between a mobile backhaul hub 200 and a mobile backhaul terminal 310. An access link for providing a 4G or 5G mobile communication system is present between a flying base station 320 and a user terminal 500. A C2 link for transmitting state information and control information is present between the aerial vehicle 300 on which the flying base station 320 and the mobile backhaul terminal 310 are mounted and an aerial vehicle management apparatus 400. A wireless (e.g., WLAN) link or a wired link for transmitting state information and control information is present between the aerial vehicle management apparatus 400 and the mobile backhaul hub 200. A wired link is present between the mobile backhaul hub 200 and the core network 100.

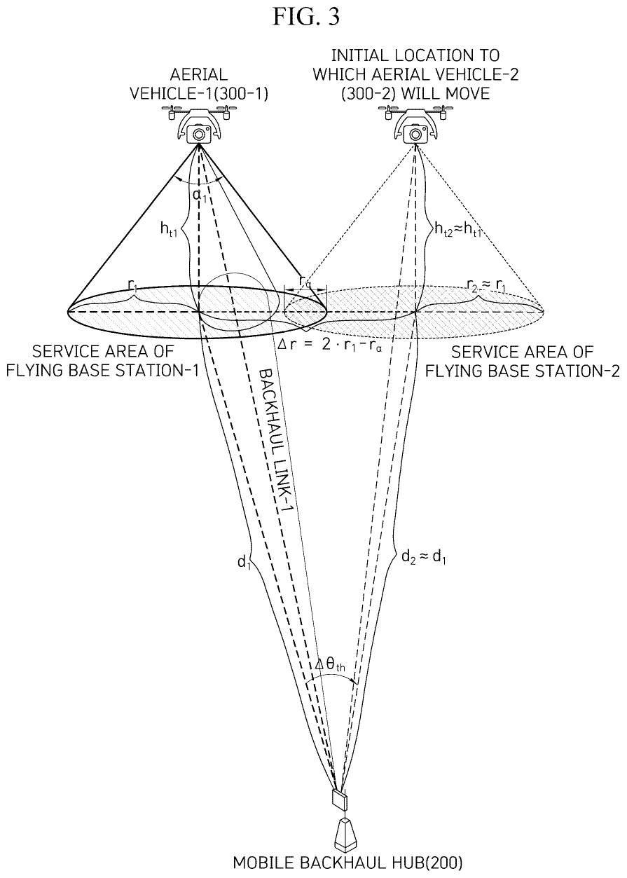

FIG. 3 is a concept view illustrating an example of the setting of an initial location at which a new aerial vehicle will be moved for the replacement of an aerial vehicle according to an embodiment of the present disclosure.

Referring to FIG. 3, an aerial vehicle—1 300-1 that transmits information on GPS locations and state information thereof to the aerial vehicle management apparatus 400 at a predetermined cycle is spaced apart from the mobile backhaul hub 200 at a separation distance “d₁”. A flying base station-1 320-1 mounted on the aerial vehicle—1 300-1 provides a service to the user terminal 500 within a service cell radius “r1” having a predetermined size.

While the service is provided, the aerial vehicle management apparatus 400 determine whether to replace the aerial vehicle—1 300-1 by analyzing the state information received from the aerial vehicle—1 300-1. When determining to replace the aerial vehicle—1 300-1, the aerial vehicle management apparatus 400 calculates an initial location of an aerial vehicle—2 300-2 by considering the separation distance “d₁”, the service cell radius “r₁”, a service cell radius “r₂” of a flying base station-2 320-2 mounted on an aerial vehicle—2 300-2, the maximum diameter “r_{α}) of a handover overlap area, and moves the aerial vehicle—2 300-2 to the initial location.

The separation distance “d₁” and the radius “r₁” of the service area of the flying base station-1 320-1 using information (i.e., latitude and longitude) on the GPS locations of the mobile backhaul hub 200 and the aerial vehicle—1 300-1 are calculated like Equations 1 and 2.

$${d}_{1} = \sqrt{{( {φ}_{t 1} - {φ}_{h} )}^{2} + {( {λ}_{t 1} - {λ}_{h} )}^{2}} \qquad ( 1 )$$

In Equation 1, (φₕ, φₜ₁) and (λₕ, λₜ₁) indicate latitude and longitude of the mobile backhaul hub 200 and the aerial vehicle—1 300-1.

$${r}_{1} = {h}_{t 1} \cdot tan ( \frac{{α}_{1}}{2} ) \qquad ( 2 )$$

In Equation 2, hₜ₁ and α₁ indicate information (altitude) on the GPS locations of the aerial vehicle—1 300-1 and a beam angle that is used for a service by the flying base station-1 320-1.

When the separation distance “d₁” between the mobile backhaul hub 2 to the aerial vehicle—1 300-1 and the radius “r1” of the cell area in which the flying base station-1 320-1 provides a service are determined based on Equations 1 and 2, the aerial vehicle management apparatus 400 that is connected to the flying base station-1 320-1 calculates an angle of interference Δθₜₕ that is formed by the aerial vehicle—1 300-1 and the aerial vehicle—2 300-2 to be replaced, into which a maximum diameter “r_{α}” of the overlap area has been incorporated by considering handover to the flying base station-2 320-2.

In calculating the angle of interference Δθₜₕ that is formed by the aerial vehicle—1 300-1 and the aerial vehicle—2 300-2 to be replaced, the separation distance “d₂” between the aerial vehicle—2 300-2 and the mobile backhaul hub 200 is the same as the separation distance “d₁” of the aerial vehicle—1 300-1 (d₂≈d₁). The radius “r₂” of the cell area of the flying base station-2 320-2 mounted the aerial vehicle—2 300-2 is similar to the radius “r₁” of the cell area of the flying base station-1 320-1 mounted on the aerial vehicle—1 300-1 (r₂≈r₁). Furthermore, assuming that some areas overlaps by the maximum diameter “r_{α}”, the angle of interference Δθₜₕ for moving the aerial vehicle—1 300-1 from a current location of the aerial vehicle—1 300-1 to a virtual location of the aerial vehicle—2 300-2 to be replaced may be calculated like Equation 3 according to a cosine second-law.

$${Δθ}_{th} = {cos}^{- 1} ( 1 - {( \frac{Δ r}{\sqrt{2} \cdot {d}_{1}} )}^{2} ) \qquad ( 3 )$$

In Equation 3, Δr=r₁+r₂−r_{α}=2·r₁−r_{α1}0≤r_{α}<r₁.

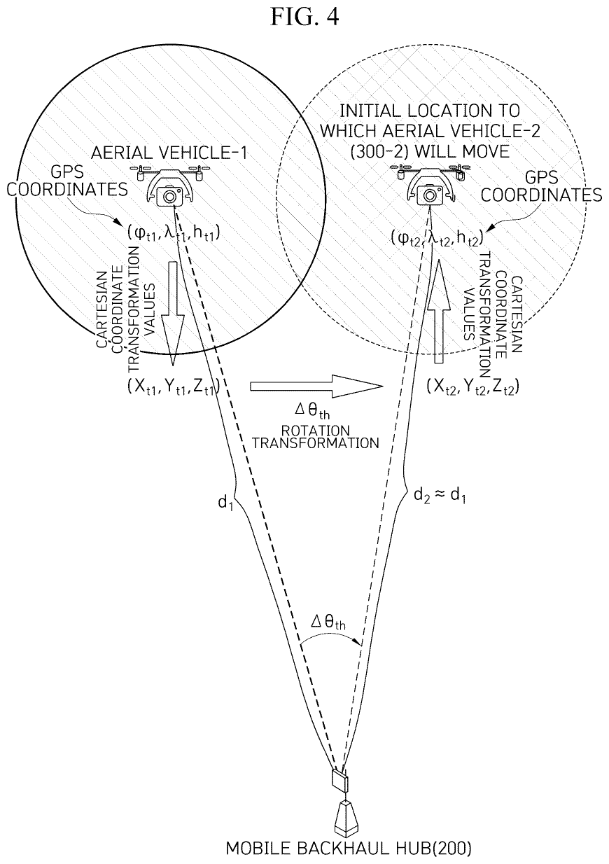

FIG. 4 illustrates a process of obtaining an initial location to which a new aerial vehicle will be moved for replacement according to an embodiment of the present disclosure.

Referring to FIG. 4, the aerial vehicle management apparatus 400 that receives information (i.e., latitude, longitude, and altitude) on the GPS locations of the aerial vehicle—1 300-1 transforms the information on the GPS locations into values of a three-dimensional (3-D) Cartesian coordinate system through 3-D Cartesian coordinate system transformation.

The values of the 3-D Cartesian coordinate systems are transformed into 3-D rotation transformation values by the angle of interference Δθₜₕ by using 3-D rotation transformation. The 3-D rotation transformation values are transformed into values of information (i.e., latitude, longitude, altitude) on the GPS locations again through 3-D Cartesian coordinate system transformation.

Through such a process, an initial location at which the aerial vehicle—2 300-2 will be placed is obtained.

Equation 4 is an equation for obtaining coordinates (Xₜ₁, Yₜ₁, Zₜ₁) transformed into a geocentric coordinate system based on 3-D Cartesian coordinates in which the center of the earth is an original point with respect to information (φₜ₁, λₜ₁, hₜ₁) on the GPS locations of the aerial vehicle—1 300-1.

$${X}_{t 1} = ( R + {h}_{t 1} ) \cdot cos ( {φ}_{t 1} ) \cdot cos ( {λ}_{t 1} ) \qquad ( 4 )$$

$${Y}_{t 1} = ( R + {h}_{t 1} ) \cdot cos ( {φ}_{t 1} ) \cdot sin ( {λ}_{t 1} )$$

$${Z}_{t 1} = ( R + {h}_{t 1} ) \cdot sin ( {φ}_{t 1} )$$

In Equation 4, R indicates an average radius of a spherical model in which the center of the earth is placed at the original point.

Equation 5 is an equation for obtaining new coordinates (Xₜ₂, Yₜ₂, Zₜ₂) that have been subjected to 3-D rotation transformation by the angle of interference Δθₜₕ obtained according to Equation 3, with respect to the coordinates (Xₜ₁, Yₜ₁, Zₜ₁) obtained according to Equation 4.

$$[ \begin{matrix}{X}_{t 2} \\ {Y}_{t 2} \\ {Z}_{t 2}\end{matrix} ] = [ \begin{matrix}cos ( {Δθ}_{th} ) & - sin ( {Δθ}_{th} ) & 0 \\ sin ( {Δθ}_{th} ) & cos ( {Δθ}_{th} ) & 0 \\ 0 & 0 & 1\end{matrix} ] \cdot [ \begin{matrix}{X}_{t 1} \\ {Y}_{t 1} \\ {Z}_{t 1}\end{matrix} ] \qquad ( 5 )$$

Equation 6 is an equation for obtaining information (φₜ₂, λₜ₂, hₜ₂) on the GPS locations of the aerial vehicle—2 300-2, which corresponds to the new coordinates (Xₜ₂, Yₜ₂, Zₜ₂) obtained by the 3-D rotation transformation in Equation 5.

$${φ}_{t 2} = {tan}^{- 1} ( \frac{{Z}_{t 2}}{\sqrt{{X}_{t 2}^{2} + {Y}_{t 2}^{2}}} ) \qquad ( 6 )$$

$${λ}_{t 2} = {tan}^{- 1} ( \frac{{Y}_{t 2}}{{X}_{t 2}} )$$

$${h}_{t 2} \approx {h}_{t 1}$$

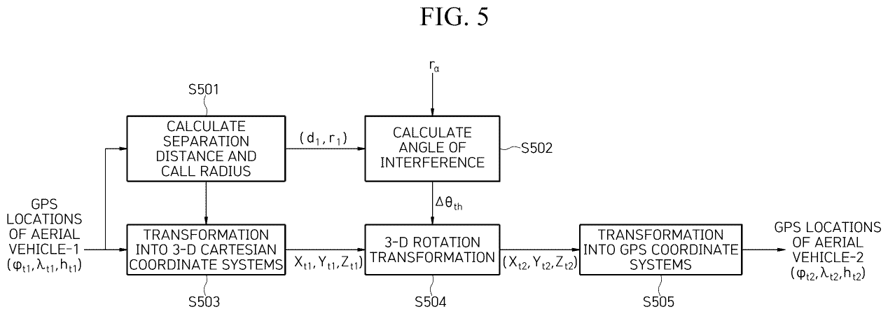

FIG. 5 is a flowchart of a process of calculating an initial location to which a new aerial vehicle will be moved for replacement according to an embodiment of the present disclosure.

Referring to FIG. 5, when determining that a new aerial vehicle needs to be moved for replacement, in step S501, the aerial vehicle management apparatus 400 calculates the separation distance “d₁” based on information ((φₕ, λₕ, hₕ) on GPS locations received from the mobile backhaul hub 200 and information ((φₜ₁, φₕ, hₕ) on GPS locations received from the aerial vehicle—1 300-1, and calculates the service cell radius “r₁” by using a beam angle that is used by the flying base station-1 320-1 mounted on the aerial vehicle—1 300-1 in order to provide a service.

In step S502, during a process of replacing an aerial vehicle, the aerial vehicle management apparatus 400 calculates the angle of interference Δθₜₕ in which the maximum diameter “r_{α}” of a handover area in which the service areas of the flying base stations 320-1 and 320-2 overlap has been considered.

Furthermore, in step S503, the aerial vehicle management apparatus 400 transforms the information (φₜ₁, λₜ₁, hₜ₁) on the GPS locations, which has been received from the aerial vehicle—1 300-1, into 3-D Cartesian coordinate systems in order to obtain the Cartesian coordinate values (Xₜ₁, Yₜ₁, Zₜ₁).

In step S504, the aerial vehicle management apparatus 400 performs 3-D rotation transformation on the transformed Cartesian coordinate values (Xₜ₁, Yₜ₁, Zₜ₁) by the angle of interference Δθₜₕ calculated in step S502.

In step S505, the aerial vehicle management apparatus 400 obtains the information (φₜ₂, λₜ₂, hₜ₂) on the GPS locations of an initial location to which the aerial vehicle—2 320-2 will move by transforming the rotation transformation values (Xₜ₂, Yₜ₂, Zₜ₂) obtained in step S504 into 3-D Cartesian coordinate systems.

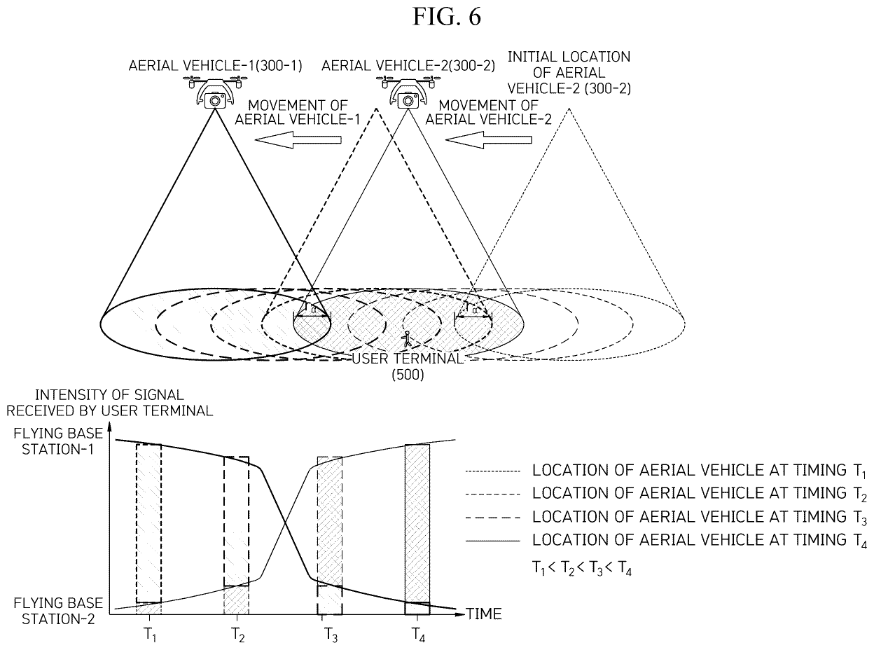

FIG. 6 illustrates an example in which the existing aerial vehicle and a new aerial vehicle are moved for the replacement of the existing aerial vehicle according to an embodiment of the present disclosure.

Referring to FIG. 6, when information on the GPS locations of the aerial vehicle—2 300-2 for an initial location of the aerial vehicle—2 300-2 is determined through 3-D Cartesian coordinate system transformation and 3-D rotation transformation from information on the GPS locations of the aerial vehicle—1 300-1, the aerial vehicle management apparatus 400 instructs the aerial vehicle—2 300-2 to move to the initial location.

When the movement of the aerial vehicle—2 300-2 to the initial location is completed, the aerial vehicle management apparatus 400 moves the aerial vehicle—2 300-2 to the location of the aerial vehicle—1 300-1 and simultaneously moves the aerial vehicle—1 300-1 in the same direction as that of the aerial vehicle—2 300-2 for the replacement of the aerial vehicle—2 300-2.

The user terminal 500 that is served by the flying base station-1 320-1 periodically measures the intensity of a signal received from the flying base station-2 320-2 for handover. When determining that the intensity of the received signal of the flying base station-2 320-2, which is measured by the user terminal 500, is greater than the intensity of a received signal of the flying base station-1 320-1 that provides the existing service, the user terminal 500 performs handover from the flying base station-1 320-1 to the flying base station-2 320-2.

When the movement of the aerial vehicle—2 300-2 to the location of the aerial vehicle—1 300-1 at timing T1 is completed, the aerial vehicle management apparatus 400 determines that the replacement of the aerial vehicle has been completed, and instructs the aerial vehicle—1 300-1 to return.

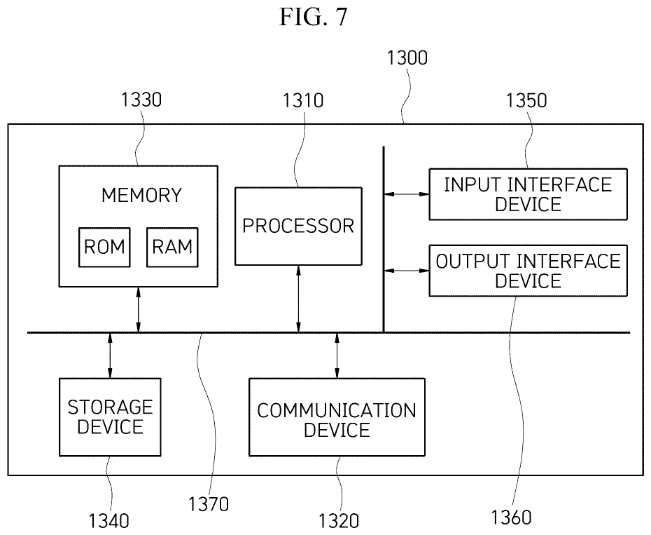

FIG. 7 is a block diagram illustrating a computer system that implements a method according to an embodiment of the present disclosure.

Referring to FIG. 7, a computer system 1300 may include at least one of a processor 1310, memory 1330, an input interface device 1350, an output interface device 1360, and a storage device 1340, which perform communication through a bus 1370. The computer system 1300 may further include a communication device 1320 that is connected to a network. The processor 1310 may be a central processing unit (CPU) or may be a semiconductor device that executes a command stored in the memory 1330 or the storage device 1340. The memory 1330 and the storage device 1340 may each include various forms of volatile or nonvolatile storage media. For example, the memory may include read only memory (ROM) and random access memory (RAM). In an embodiment of this specification, the memory may be disposed inside or outside the processor. The memory may be connected to the processor through various already-known means. The memory may be various forms of volatile or nonvolatile storage media. For example, the memory may include read-only memory (ROM) or random access memory (RAM).

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A method of setting an initial location of an aerial vehicle for a replacement of the aerial vehicle of a mobile backhaul system, which is performed by an apparatus for setting an initial location of an aerial vehicle for the replacement of the aerial vehicle of the mobile backhaul system, the method comprising steps of:
(a) obtaining a first separation distance between a mobile backhaul hub and a first aerial vehicle;
(b) obtaining a second separation distance between a second aerial vehicle and the mobile backhaul hub by considering a location of the first aerial vehicle, a service area radius of a first flying base station mounted on the first aerial vehicle, and information on a handover overlap area in which handover to a second aerial vehicle is considered;
(c) calculating an angle of interference for three-dimensional (3-D) rotation transformation based on the first separation distance and the second separation distance; and
(d) calculating location information of the second aerial vehicle to be replaced based on coordinate transformation and 3-D rotation transformation with respect to the location information of the first aerial vehicle.

2. The method of claim 1, wherein the step (a) comprises calculating the first separation distance based on latitude and longitude of the mobile backhaul hub and the first aerial vehicle.

3. The method of claim 1, wherein the step (b) comprises calculating the service area radius of the first flying base station based on information on GPS locations of the first aerial vehicle and a beam angle that is used by the first flying base station in order to provide a service.

4. The method of claim 1, wherein the step (b) comprises obtaining the second separation distance by considering the information on the handover overlap area comprising a maximum diameter of the handover overlap area.

5. The method of claim 1, wherein the step (c) comprises calculating the angle of interference by considering a relationship between the first separation distance and the second separation distance and a relationship between the service area radii of the first flying base station and a second flying base station mounted on the first aerial vehicle and the second aerial vehicle, respectively.

6. The method of claim 1, wherein the step (d) comprises obtaining an initial location at which the second aerial vehicle is to be located by performing 3-D Cartesian coordinate system transformation on information on GPS locations of the first aerial vehicle, performing 3-D rotation transformation on transformation values by considering an angle of interference, and transforming 3-D rotation transformation values into values of the information on the GPS locations again through 3-D Cartesian coordinate system transformation.

7. An apparatus for setting an initial location of an aerial vehicle for a replacement of the aerial vehicle of a mobile backhaul system, the apparatus comprising:
an input interface device configured to obtain input information comprising location information of a mobile backhaul hub and a first aerial vehicle to be replaced;
memory in which a program that calculates an initial location of a second aerial vehicle that replaces the first aerial vehicle and moves the second aerial vehicle based on the input information has been stored; and
a processor configured to execute the program,
wherein the processor determines information on an initial location of the second aerial vehicle that replaces the first aerial vehicle by transforming the location information of the first aerial vehicle.

8. The apparatus of claim 7, wherein the input information further comprises a service cell radius of a flying base station and information on handover of a user terminal that receives a service from the flying base station.

9. The apparatus of claim 8, wherein the processor determines the information on the initial location of the second aerial vehicle, by obtaining a first separation distance between the mobile backhaul hub and the first aerial vehicle, obtaining a second separation distance between the mobile backhaul hub and the second aerial vehicle by considering a service area radius of a first flying base station mounted on the first aerial vehicle and information on a handover overlap area, calculating an angle of interference based on the first separation distance and the second separation distance, and transforming the location information of the first aerial vehicle based on the angle of interference.

10. The apparatus of claim 9, wherein the processor
calculates first coordinates by transforming the location information of the first aerial vehicle into geocentric coordinate systems,
calculates second coordinates by performing three-dimensional (3-D) rotation transformation on the transformed first coordinates by the angle of interference, and
determines information on the initial location of the second aerial vehicle by transforming the transformed second coordinates into geodetic coordinate systems.

11. A mobile backhaul system comprising:
a first aerial vehicle on which a flying base station and a mobile backhaul terminal are mounted; and
an aerial vehicle management apparatus configured to determine whether the first aerial vehicle needs to be replaced by receiving state information from the first aerial vehicle and analyzing the state information, calculate an initial location of a second aerial vehicle that replaces the first aerial vehicle by considering a separation distance, a service cell radius, and a maximum diameter of a handover overlap area when determining to replace the first aerial vehicle, and move the second aerial vehicle to the initial location.

12. The mobile backhaul system of claim 11, wherein the aerial vehicle management apparatus:
obtains a second separation distance between the mobile backhaul hub and the second aerial vehicle by considering a first separation distance between the mobile backhaul hub and the first aerial vehicle, a service area radius of a first flying base station mounted on the first aerial vehicle, and a maximum diameter in which handover to the second aerial vehicle is considered, and
calculating an angle of interference for three-dimensional (3-D) rotation transformation based on the first separation distance and the second separation distance.

13. The mobile backhaul system of claim 12, wherein the aerial vehicle management apparatus obtains the initial location at which the second aerial vehicle is to be located by performing 3-D Cartesian coordinate system transformation on location information of the first aerial vehicle, performing 3-D rotation transformation on transformation values by considering the angle of interference, and transforming 3-D rotation transformation values into values of the location information again through 3-D Cartesian coordinate system transformation.
